(19) United States
(12) Patent Application Publication
(10) Pub. No.: US 2016/0294465 A1
(43) Pub. Date: Oct. 6, 2016

(54) INFORMATION COLLECTION SYSTEM, RELAY TERMINAL, CONTROL METHOD FOR RELAY TERMINAL TO CONNECT TO CENTER SYSTEM, SENSOR TERMINAL, AND CONTROL METHOD FOR SENSOR TERMINAL TO CONNECT TO CENTER SYSTEM

(71) Applicant: HITACHI, LTD., Tokyo (JP)

(72) Inventors: Satoshi HASHIMOTO, Tokyo (JP); Takahiro SASAKI, Tokyo (JP); Kazumasa AZUMA, Tokyo (JP)

(73) Assignee: HITACHI, LTD., Tokyo (JP)

(21) Appl. No.: 14/967,501

(22) Filed: Dec. 14, 2015

(30) Foreign Application Priority Data
Mar. 31, 2015 (JP) 2015-072197

(51) Int. Cl. H04B 7/14; H04W 48/16; H04W 4/00

(52) U.S. Cl. CPC H04B 7/14; H04W 4/005; H04W 48/16; H04W 84/12

(57) ABSTRACT

An information collection system comprises a center system and relay terminals connectable to the center system via a network. the center system includes a first server for each of the relay terminals to initially connect to, a second server for each of the relay terminals to send sensor information and a third server configured to manage the first server and the second server. The relay terminal includes a first storage unit configured to hold relay terminal information for managing information on an operating channel to be used by the relay terminal and information to connect to the first server and a relay terminal operation start unit configured to select an operating channel to be used by the relay terminal from channels scanned based on information on candidate operating channels for the relay terminal received from the third server via the first server.

### CLAIM OF PRIORITY

The present application claims priority from Japanese patent application JP 2015-72197 filed on Mar. 31, 2015, the content of which is hereby incorporated by reference into this application.

### BACKGROUND OF THE INVENTION

This invention relates to an information collection system, a relay terminal, a control method for the relay terminal to connect to a center system, a sensor terminal, and a control method for the sensor terminal to connect to the center system.

In recent years, development of information communication networks, communication technology, and communication equipment, and advancement of sensor network technology and information processing systems have inspired the demand for public wireless LAN (Local Area Network) systems and M2M (Machine-to-Machine) systems. Such systems need an arrangement to prevent interference of radio waves among wireless terminals in an environment, for example, where the wireless terminals are provided within a close range.

To check for radio wave interference and automatically select an operating channel, a technique is disclosed in JP 2012-54745 A. According to the Abstract of JP 2012-54745 A, provided is a wireless LAN device capable of easily determining a channel optimal for operation even in a complex wireless LAN network environment. Specifically, JP 2012-54745 A discloses a method that the wireless LAN device scans the channels in the nearby area based on a predetermined channel list, reads the RSSI (Received Signal Strength Indicator) upon receipt of a frame from another wireless LAN device, and starts operation on the channel that provides the most stable communication quality based on the information.

In addition, there exists a method described in IEEE 802.11™—2007 IEEE Standard for information technology—Telecommunications and information exchange between systems—Local and metropolitan area networks—Specific requirements Part 11: Wireless LAN Medium Access Control (MAC) and Physical Layer (PHY) Specifications, 10.3.2 Scan. Specifically, a terminal scans the channels in the nearby area based on a predetermined channel list and selects an access point that shows the highest RSSI at receipt of a beacon frame from the access point.

A M2M system aggregates diverse types of sensor terminals of various kinds of businesses into a single system and collects a massive amount of information. Accordingly, collected sensor information needs to be managed for individual users to hold the sensor information (for example, electric power companies) or individual locations of relay terminals to relay information sent from sensor terminals. In the meanwhile, a desirable network topology for an environment including a plurality of relay terminals and sensor terminals is such that each relay terminal is connected with an approximately equal number of sensor terminals to balance the traffic.

According to the existing techniques, a relay terminal automatically selects a channel in a multi-channel environment where a large number of relay terminals are provided. For this reason, the relay terminal may select a different channel every time the relay terminal joins the system. A sensor terminal may connect to a different relay terminal at every connection in a multi-channel environment where a large number of sensor terminals are provided.

According to the existing techniques, the information on operating channels is preset in each terminal. However, a large-scale system includes a huge number of terminals; presetting the channel information to each terminal increases the man-hours.

### SUMMARY OF THE INVENTION

This invention has been accomplished to challenge the aforementioned issues and an object of this invention is to provide a terminal that is capable of automatically selecting an operating channel without terminal-specific channels preset to the terminal. Another object of this invention is to provide a terminal that is capable of selecting an operating channel to prevent interference of radio waves in a nearby area using an intended network topology.

The information collection system of an aspect of the invention disclosed herein includes relay terminals connectable to a center system via a network. The center system includes a first server for each of the relay terminals to initially connect to, a second server for each of the relay terminals to send sensor information, and a third server configured to manage the first server and the second server.

Each relay terminal holds relay terminal information for managing an operating channel to be used by the relay terminal and information to connect to the first server. The relay terminal selects an operating channel to be used by the relay terminal from channels scanned based on information on candidate operating channels for the relay terminal received from the third server via the first server.

Each sensor terminal holds sensor terminal information for managing information on an operating channel to be used by the sensor terminal and information on candidate channels to be scanned. The sensor terminal selects an operating channel for the sensor terminal to use to connect to a relay terminal from channels scanned based on the information on candidate channels to be scanned stored in a storage unit. The sensor terminal stores the selected operating channel to be used by the sensor terminal to the sensor terminal information. The sensor terminal checks whether information on candidate operating channels for the sensor terminal received from the center system via a connected relay terminal includes the operating channel to be used by the sensor terminal stored in the sensor terminal information. The sensor terminal sends collected sensor information to the connected relay terminal on the operating channel to be used by the sensor terminal stored in the sensor terminal information in a case where a result of the checking is affirmative.

The center system holds, in advance, information on operating channels for the relay terminals as configuration information on the relay terminals and information on operating channels for the sensor terminals as configuration information on the sensor terminals. In joining the system, a relay terminal or a sensor terminal acquires configuration information including information on operating channels for the relay terminal or the sensor terminal from the center system and selects a channel from the acquired information on operating channels to start operation.

According to a representative embodiment of this invention, a relay terminal or a sensor terminal can self-reliantly select an operating channel before apparatus activation even if operating channels are not preset in advance of the apparatus activation. As a result, channel presetting can be eliminated, which lowers the cost of manufacturing and managing the shipment of the relay terminal or the sensor terminal. Furthermore, in an environment including a large number of relay terminals and sensor terminals using multiple channels, operating channels are determined to be suitable for the network topology intentionally designed by the center administrator; effective bandwidth usage and balanced traffic are achieved. Other features, aspects, and advantages of the subject matter will become apparent from the description, the drawings, and the claims.

### BRIEF DESCRIPTION OF THE DRAWINGS

FIG. 1 is a system configuration diagram for illustrating a configuration example of an M2M system.

FIG. 2 is a block diagram for illustrating a configuration example of the integrated management center.

FIG. 3 is an explanatory diagram for illustrating an example of information stored in the GW management table held by the integrated management center.

FIG. 4 is an explanatory diagram for illustrating an example of information stored in the SN management table held by the integrated management center.

FIG. 5 is a block diagram for illustrating an example of the hardware configuration of the INIT center.

FIG. 6 is a block diagram for illustrating a configuration example of a DCC center.

FIG. 7 is a block diagram for illustrating a configuration example of a GW.

FIG. 8 is an explanatory diagram for illustrating examples of information stored in the GW own node information table held by the GW.

FIG. 9 is a block diagram for illustrating a configuration example of an SN 106.

FIG. 10 is a block diagram for illustrating examples of information stored in the SN own node information table held by the SN.

FIG. 11 is an explanatory diagram for illustrating an example of the operation sequence for a GW to join the network.

FIG. 12 is a flowchart for illustrating an example of starting operation of the GW in the wireless zone.

FIG. 13A is an explanatory diagram for illustrating examples of a sequence for the SN to join the network.

FIG. 13B is an explanatory diagram for illustrating examples of a sequence for the SN to join the network.

FIG. 14 is a flowchart for illustrating an example of processing to select a GW to connect to in the SN.

FIG. 15 is a flowchart for illustrating an example of channel confirmation in the SN.

### DETAILED DESCRIPTION OF THE EMBODIMENTS

### Example of System Configuration

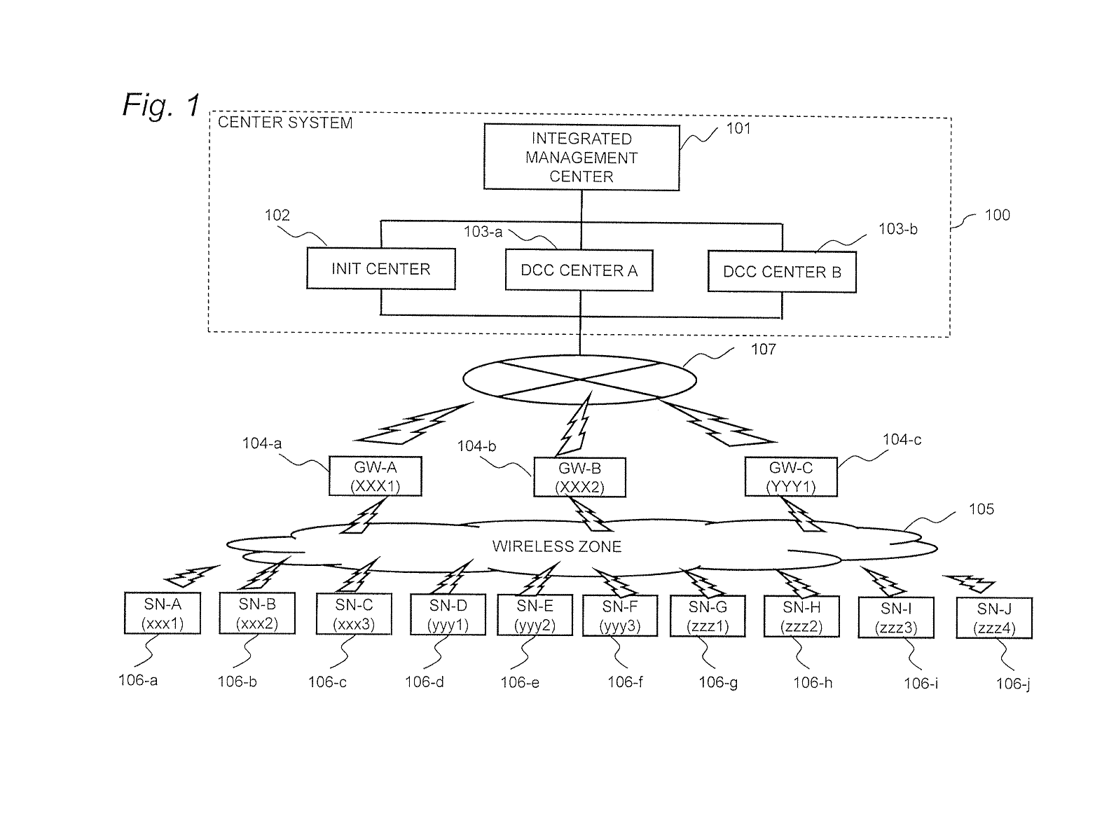

FIG. 1 is a system configuration diagram for illustrating a configuration example of an M2M system. The M2M system 1 in FIG. 1 is an information collection system in which a center system 100 and relay terminals (gateways: hereinafter referred to as GWs) 104 are connected via a network 107. A wireless zone 105 is provided between the GWs 104 and sensor terminals (sensor nodes: hereinafter referred to as SNs) 106 to connect them by wireless lines. In this embodiment, connection of a GW 104 with an SN 106 using a wireless line is referred to as wireless connection.

The network 107 can be a wireless network like mobile lines (3G, or 4G (LTE: Long Term Evolution)) or WiMAX (Worldwide Interoperability for Microwave Access), or otherwise a wired network like ISDN or optical lines; the network 107 can be any type of network. In the case where the network 107 is a wireless network, the center system 100 can be of a cloud type. In the case where the network 107 is a wired network, the center system 100 can be of an on-premise type. A GW 104 and an SN 106 may be integrated into a single apparatus. The wireless zone 105 is a system in which, for example, ten SNs 106 and three GWs 104 can communicate.

Each of the SNs 106-a to 106-j is connected to any one of the GWs 104-a to 104-c via the wireless zone 105. Each GW 104 in FIG. 1 is shown with an ID in parentheses. This ID is the ID stored in the GW apparatus ID 501 of a GW own node information table 50 to be described later. For example, the GW apparatus ID 501 of the GW 104-a is “XXX1”. Each SN 106 in FIG. 1 is also shown with an ID in parentheses. This ID is the ID stored in the SN apparatus ID 691 of an SN own node information table 69 to be described later. For example, the SN apparatus ID 691 of the SN 106-a is “xxx1”.

Each SN 106 has a not-shown sensor and sends sensor information collected by the sensor to a GW 104.

Each of the GWs 104-a to 104-c connects to the center system 100 via the network 107. Each GW 104 forwards sensor information received from an SN 106 to the center system 100.

In the M2M system 1, the center system 100 includes a center (Initial center: hereinafter referred to as INIT center) 102, a plurality of information collection centers (Data Collect & Control centers: hereinafter referred to as DCC centers) 103, and an integrated management center 101. The INIT center 102 is a computer to be a first contact for a GW 104 when the GW 104 initially connects to the M2M system 1. The INIT center 102 receives actions of a GW 104 to initially connect to the M2M system 1. The DCC centers 103 are computers the GWs 104 connect to. After a GW 104 completes connecting to the INIT center 102, the INIT center 102 assigns a DCC center 103 to the GW 104. The DCC center 103 receives sensor information from SNs 106 or the GW 104. The integrated management center 101 is a computer for authenticating the GWs 104 and the SNs 106 when the GWs 104 and the SNs 106 initially connect to the M2M system 1. The integrated management center 101 authenticates the SNs 106 at their initial connection, authenticates the GWs 104 at their initial connection, and aggregates collected sensor information. The INIT center 102, the DCC centers 103-a and 103-b, and the integrated management center 101 can communicate with one another.

The SNs 106-a to 106-j can communicate with the DCC centers 103-a and 103-b and the integrated management center 101 in the center system 100 via the GWs 104-a to 104-c by wireless communications through the connection with the GWs 104-a to 104-c via the wireless zone 105.

To which of the DCC centers 103-a and 103-b the individual GWs 104-a to 104-c are to connect is automatically determined by the integrated management center 101. To which of the GWs 104-a to 104-c the individual SNs 106-a to 106-j are to connect is automatically determined as described in the following.

In this embodiment, a GW 104 initially connects to the INIT center 102 upon activation of the apparatus. The GW 104 sends a GW connection request to the INIT center 102 to initially connect to the M2M system 1. The INIT center 102 forwards the GW connection request received from the GW 104 to the integrated management center 101. After authenticating the GW 104, the integrated management center 101 sends GW configuration information 163 to the GW 104. The GW configuration information 163 includes assigned DCC center information 1632 and a GW operating channel list 1631. The information will be described later.

The GW 104 selects a channel from the GW operating channel list 1631 included in the GW configuration information 163 received via the INIT center 102 and starts operation in the wireless zone 105. The operation in the wireless zone 105 in this embodiment means that the GW 104 and at least one SN 106 emit radio waves. Meanwhile, an action that the GW 104 becomes ready to send information to the DCC center 103 by starting operation in the wireless zone 105 and establishing connection to the DCC center 103 using the assigned DCC center information may be referred to as joining the network of the GW 104.

When an SN 106 connects to a GW 104 in the initial connection to the M2M system 1, the SN 106 identifies the channel used by a connectable GW 104 in the wireless zone 105 by scanning channels stored in the later-described scan channel list 694 to detect a connectable GW 104. After determining a GW 104 to connect to through the scanning, the SN 106 sends a wireless connection request to the GW 104.

The GW 104 sends a wireless connection response to the SN 106 and the SN 106 receives the wireless connection response; these operations complete connecting of the SN 106 to the GW 104 in the wireless zone 105. The SN 106 sends the GW 104 an SN connection request for initial connection to the M2M system 1. The GW 104 forwards the SN connection request received from the SN 106 to the DCC center 103. The DCC center 103 further forwards the SN connection request received from the GW 104 to the integrated management center 101.

After authenticating the SN 106, the integrated management center 101 sends the SN 106 configuration information including information on the operating channel for the SN 106 to use in the wireless zone 105 via the DCC center 103 and the GW 104.

The SN 106 selects a channel with reference to the operating channel information for the SN 106 received via the DCC center 103 and the GW 104 to start operation in the wireless zone 105. In this embodiment, an action that the SN 106 becomes ready to send information to the DCC center 103 via the GW 104 by starting operation in the wireless zone 105 may be referred to as joining the network of the SN 106.

### Configuration Example of Integrated Management Center 101

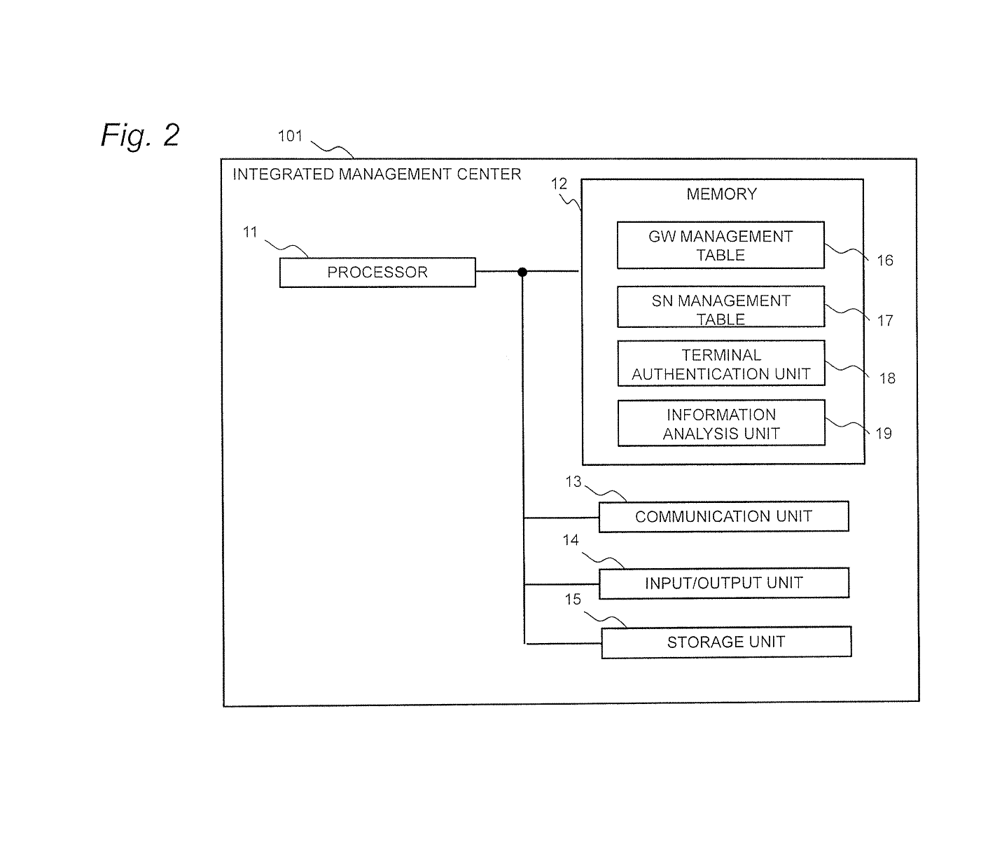

FIG. 2 is a block diagram for illustrating a configuration example of the integrated management center 101. The integrated management center 101 includes a processor 11 for performing arithmetic operations, a memory 12 for holding data and programs, a communication unit 13 for communicating with the centers 101, 102, and 103 in the center system 100, the GWs 104, and the SNs 106, an input/output unit 14 for receiving inputs from individual users (for example, an electric power company) to aggregate sensor information with the M2M system 1 and displaying information on the monitor, and a non-volatile storage unit 15 for storing programs and data. The integrated management center 101 has a function to authenticate the GWs 104 and SNs 106 at their initial connection and a function to manage configuration information on the individual GWs 104 and SNs 106.

The memory 12 stores a GW management table 16 for managing information on the GWs 104 included in the M2M system 1, an SN management table 17 for managing information on the SNs 106 included in the M2M system 1, a terminal authentication unit 18 for authenticating terminals of GWs 104 and SNs 106, and an information analysis unit 19 for analyzing a variety of information on the GWs 104 and the SNs 106 sent from the DCC centers 103. These units 18 and 19 are executed by, for example, the processor 11 to be implemented.

The processor 11 operates in accordance with the units 18 and 19 to work as functional units for implementing predetermined functions. The processor 11 further works as functional units for implementing a plurality of processes executed by the programs. Information including programs and tables for implementing the functions of the integrated management center 101 can be stored in the storage unit 15.

### Example of Information Stored in GW Management Table 16

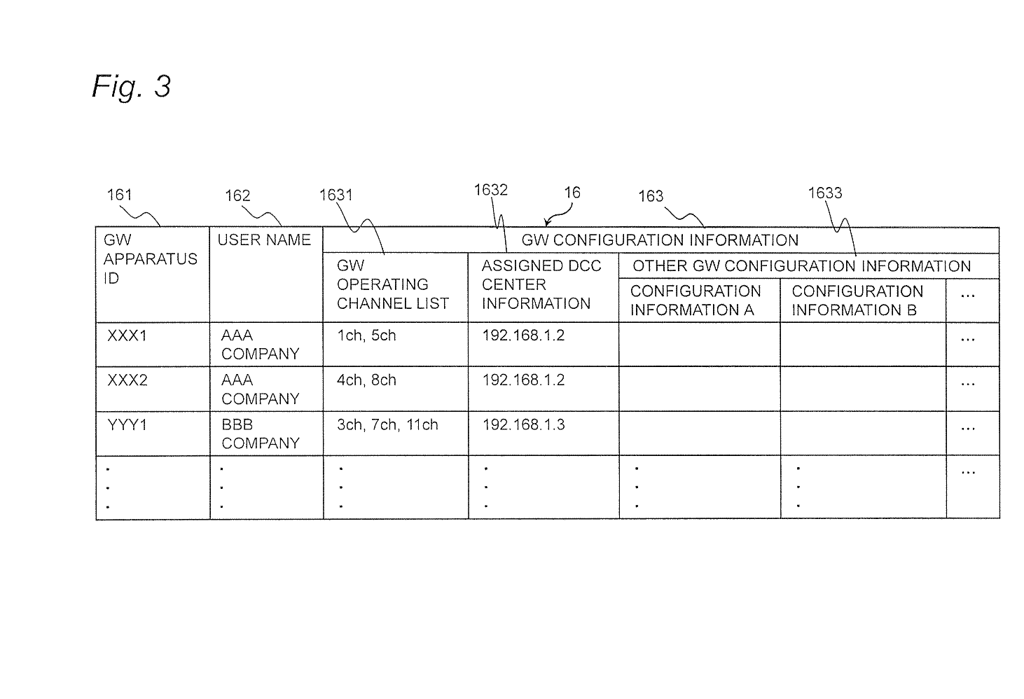

FIG. 3 is an explanatory diagram for illustrating an example of information stored in the GW management table 16 held by the integrated management center 101. The GW apparatus IDs 161, user names 162, and GW configuration information 163 managed in the GW management table 16 are registered in advance.

The GW configuration information 163 includes GW operating channel lists 1631, assigned DCC center information 1632, and other GW configuration information 1633. The information may be registered by the center administrator for operating and managing the overall center system 100 before the start of operation of the M2M system 1 or by the integrated management center 101 through calculation.

Each GW operating channel list 1631 stores a list of channels to be used by the GW 104 in the wireless zone 105. The GW operating channel list 1631 can be altered by the center administrator depending on the conditions of channel use in the wireless zone 105. Alternatively, the integrated management center 101 can automatically calculate and determine the GW operating channel list 1631 in accordance with the conditions of channel use in the wireless zone 105, for example. This embodiment does not specify the method of automatically calculating the GW operating channel list 1631; any method can be employed.

Assigned DCC center information 1632 holds information on the DCC center 103 for the GW 104 to connect to. The assigned DCC center information 1632 stores information such as an IP address or a domain.

GW configuration information 163 includes other GW configuration information 1633 to be set to the GW 104, in addition to the GW operating channel list 1631 and the assigned DCC center information 1632. An example of the other GW configuration information 1633 is a cycle of sending information from the GW 104 to the DCC center 103.

### Example of Information Stored in SN Management Table 17

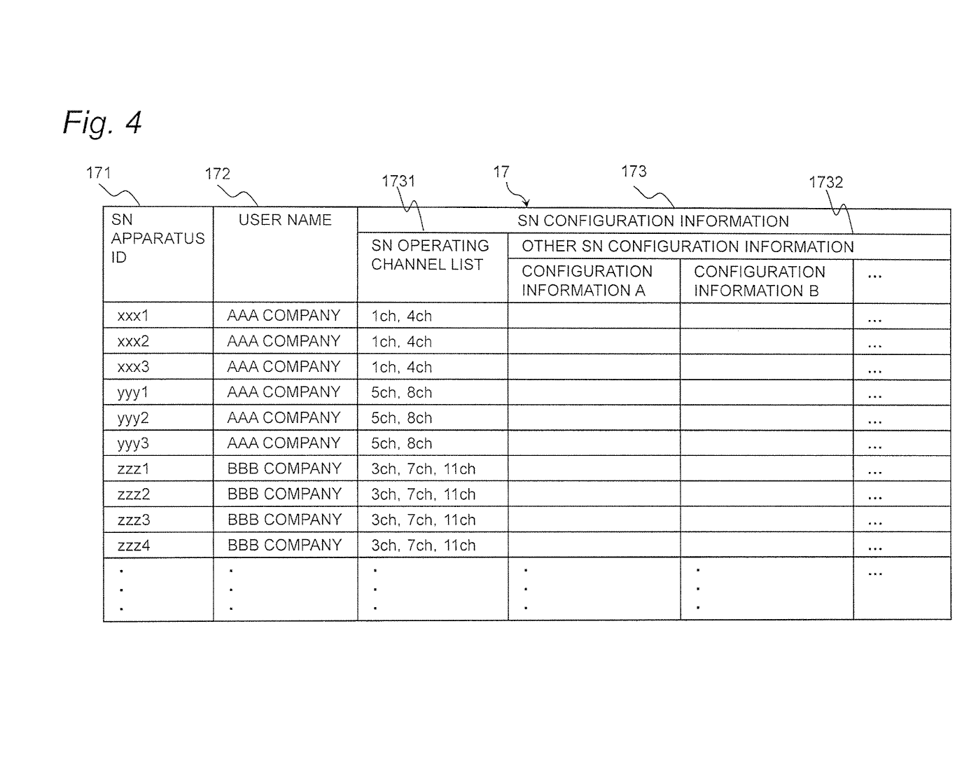

FIG. 4 is an explanatory diagram for illustrating an example of information stored in the SN management table 17 held by the integrated management center 101. The SN apparatus IDs 171, user names 172, and SN configuration information 173 managed in the SN management table 17 are registered in advance.

Each SN operating channel list 1731 holds a list of channels to be used by the SN 106 in the wireless zone 105. Like the GW operating channel list 1631 in the GW management table 16, the SN operating channel list 1731 can be altered by the center administrator depending on the conditions of channel use in the wireless zone 105. Alternatively, the integrated management center 101 can automatically calculate and determine the SN operating channel list 1731 in accordance with the conditions of channel use in the wireless zone 105, for example. This embodiment does not specify the method of automatically calculating the SN operating channel list 1731; any method can be employed.

SN configuration information 173 includes other SN configuration information 1732 to be set to the SN 106, in addition to the SN operating channel list 1731. An example of the other SN configuration information 1732 is a cycle of sending information from the SN 106 to the DCC center 103.

### Configuration Example of INIT Center 102

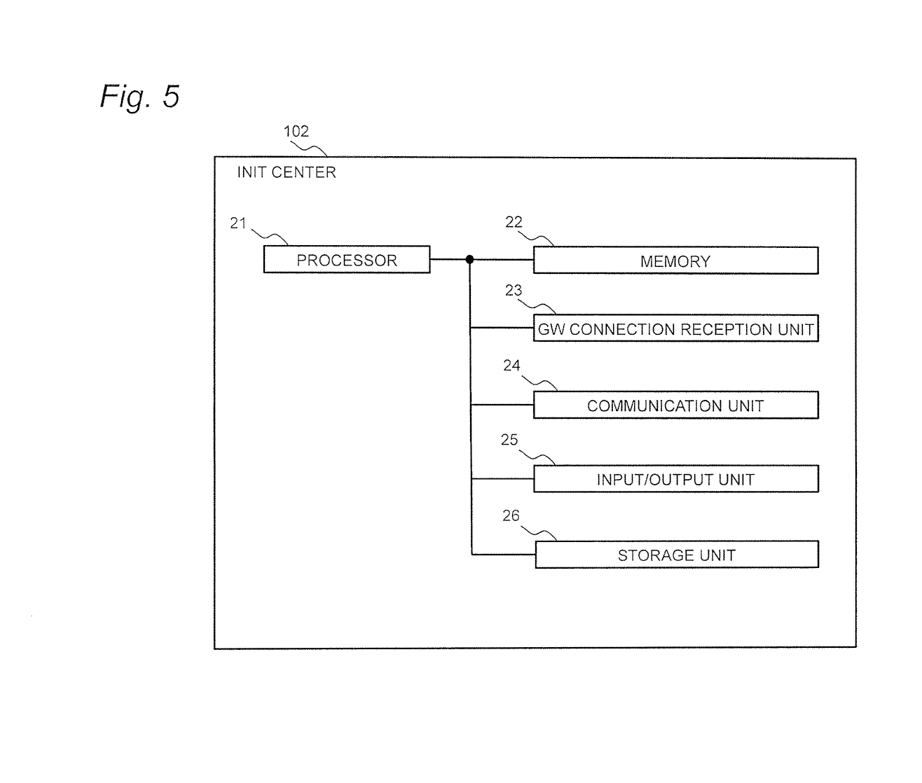

FIG. 5 is a block diagram for illustrating an example of the hardware configuration of the INIT center 102. The INIT center 102 includes a processor 21 for performing arithmetic operations, a memory 22 for holding data and programs, a GW connection reception unit 23 for accepting connection of the GWs 104 to the M2M system 1, a communication unit 24 for communicating with the centers in the center system 100, the GWs 104, and the SNs 106, an input/output unit 25 for receiving inputs from individual users and displaying information on the monitor, and a non-volatile storage unit 26 for storing programs and data.

The processor 21 operates in accordance with the programs stored in the storage unit 26 to work as functional units for implementing predetermined functions. The processor 21 further works as functional units for implementing a plurality of processes executed by the programs. Information such as the programs and data for implementing the functions of the INIT center 102 is stored in the storage unit 26.

### Configuration Example of DCC Center 103

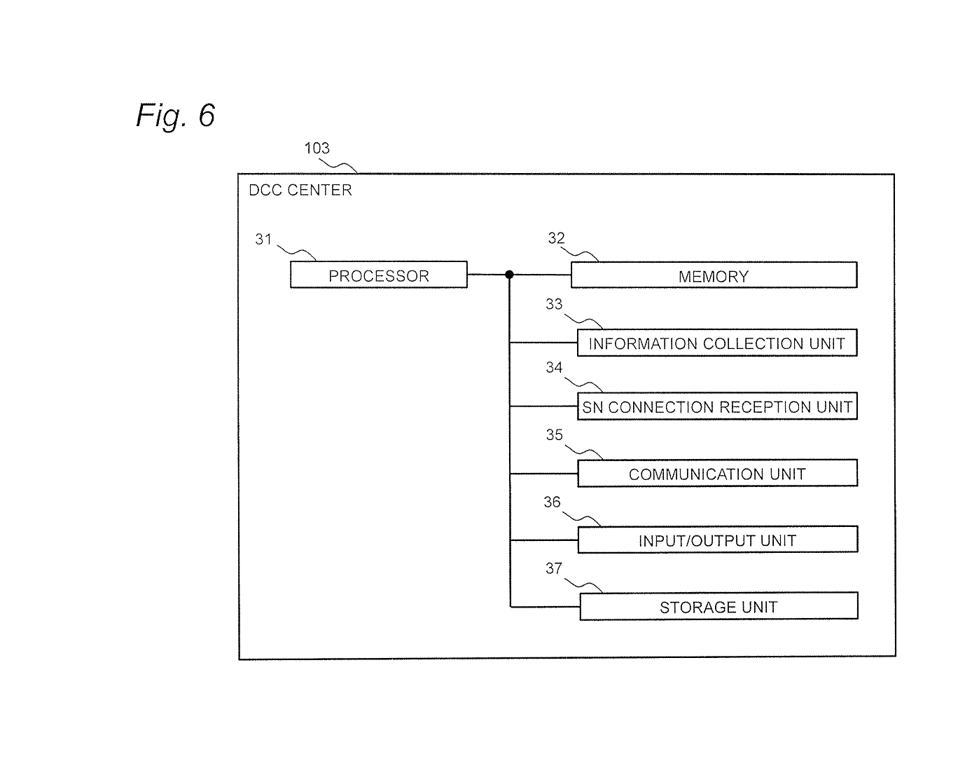

FIG. 6 is a block diagram for illustrating a configuration example of a DCC center 103. The DCC center 103 includes a processor 31 for performing arithmetic operations, a memory 32 for holding data and programs, an information collection unit 33 for collecting sensor information, statistical information, and operation information from the GWs 104 and the SNs 106, an SN connection reception unit 34 for accepting connection of the SNs 106 to the M2M system 1, a communication unit 35 for communicating with the centers in the center system 100, the GWs 104, and the SNs 106, an input/output unit 25 for receiving inputs from individual users and displaying information on the monitor, and a non-volatile storage unit 37 for storing programs and data. The information collection unit 33 also has a function to forward collected sensor information, statistical information, and operation information to the integrated management center 101. The processor 31 operates in accordance with the programs stored in the storage unit 37 to work as functional units for implementing predetermined functions. The processor 31 further works as functional units for implementing a plurality of processes executed by the programs. The information such as programs and data for implementing the functions of the DCC center 103 can be stored in the storage unit 37.

The INIT center 102 and the DCC centers 103 have a role of the first contact when a GW 104 and an SN 106 join the network. The integrated management center 101 stores classified information such as terminal information on the GWs 104 and the SNs 106 and sensor information of the users. For this reason, the integrated management center 101 does not directly connect to the network to ensure the security, by placing firewalls between the integrated management center 101 and the INIT center 102 and between the integrated management center 101 and the DCC centers 103.

### Configuration Example of GW 104

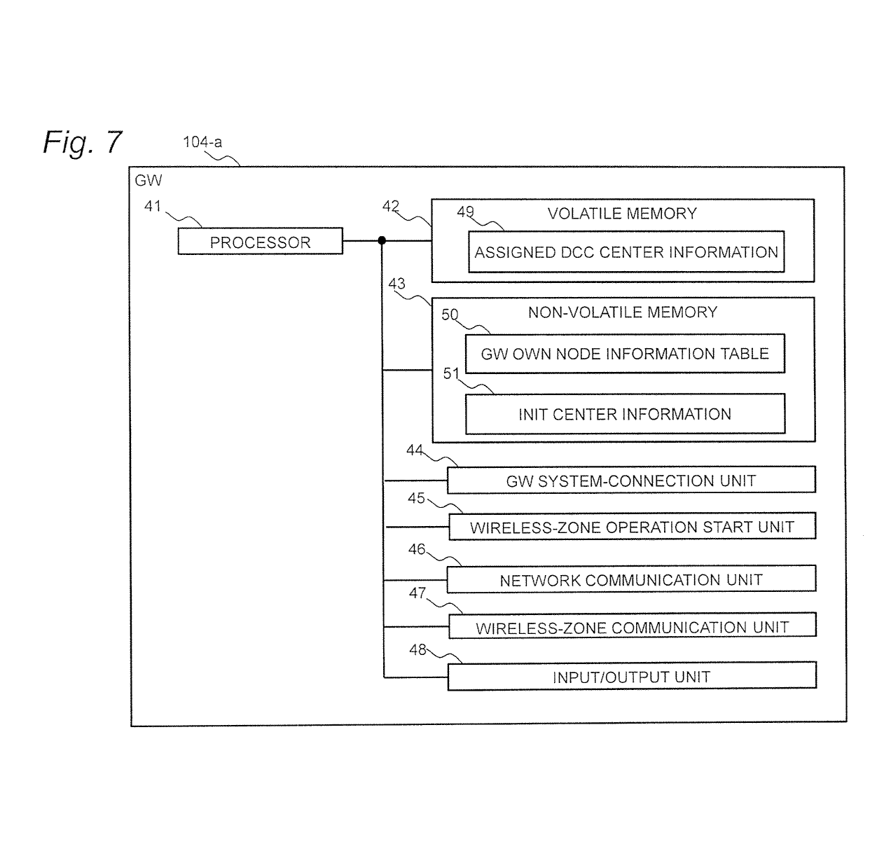

FIG. 7 is a block diagram for illustrating a configuration example of a GW 104. Although FIG. 7 provides a configuration example of the GW 104-a, the GWs 104-b and 104-c have the same configuration as the GW 104-a. The GW 104-a includes a processor 41 for performing arithmetic operations, a volatile memory 42, a non-volatile memory 43, a GW system-connection unit 44, a wireless-zone operation start unit 45, a network communication unit 46, a wireless-zone communication unit 47, and an input/output unit 48.

The volatile memory 42 holds, on a temporary basis, assigned DCC center information 49 sent from the integrated management center 101 via the INIT center 102, in addition to programs and data.

The non-volatile memory 43 holds a GW own node information table 50 and INIT center information 51, in addition to programs and data. The INIT center information 51 is information on the connection address required for the initial connection from the GW 104 to the INIT center 102 upon apparatus activation of the GW 104. The INIT center information 51 is stored in advance of the apparatus activation. For example, the INIT center information 51 may be set to the GW 104 in the factory, or in advance of the apparatus activation. Examples of the non-volatile memory 43 include storage devices such as a non-volatile semiconductor device, a hard disk drive, and an SSD (Solid State Drive), and computer-readable non-transitory data storage media such as an IC card, an SD card, a CD, and a DVD.

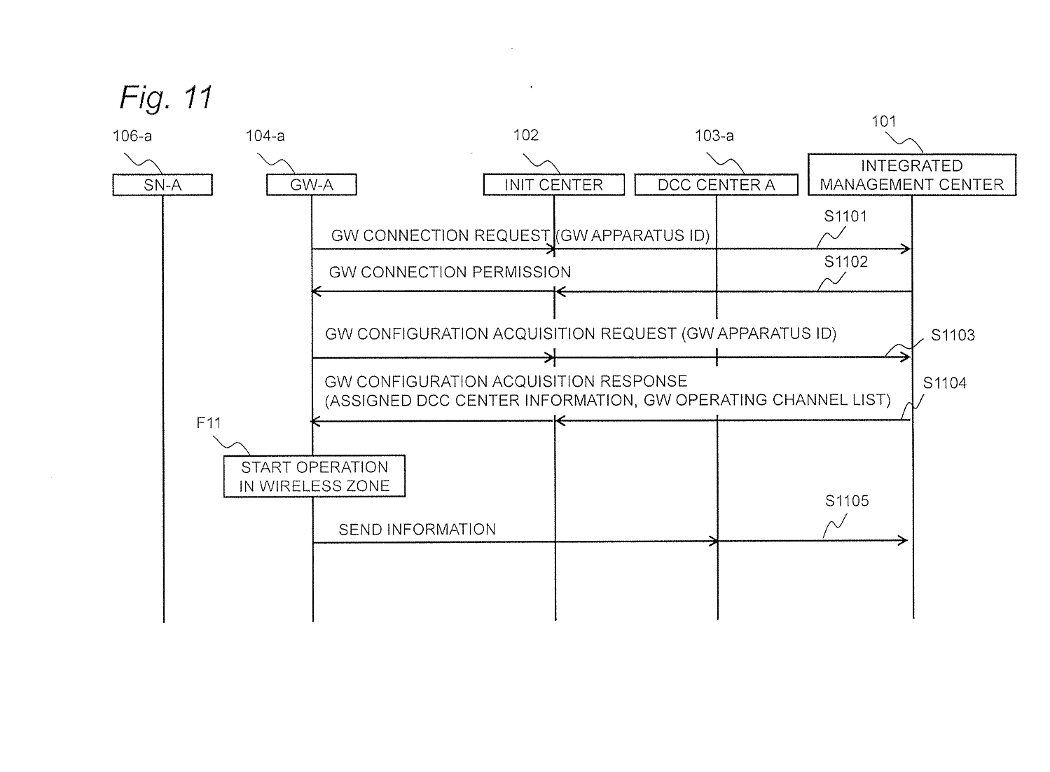

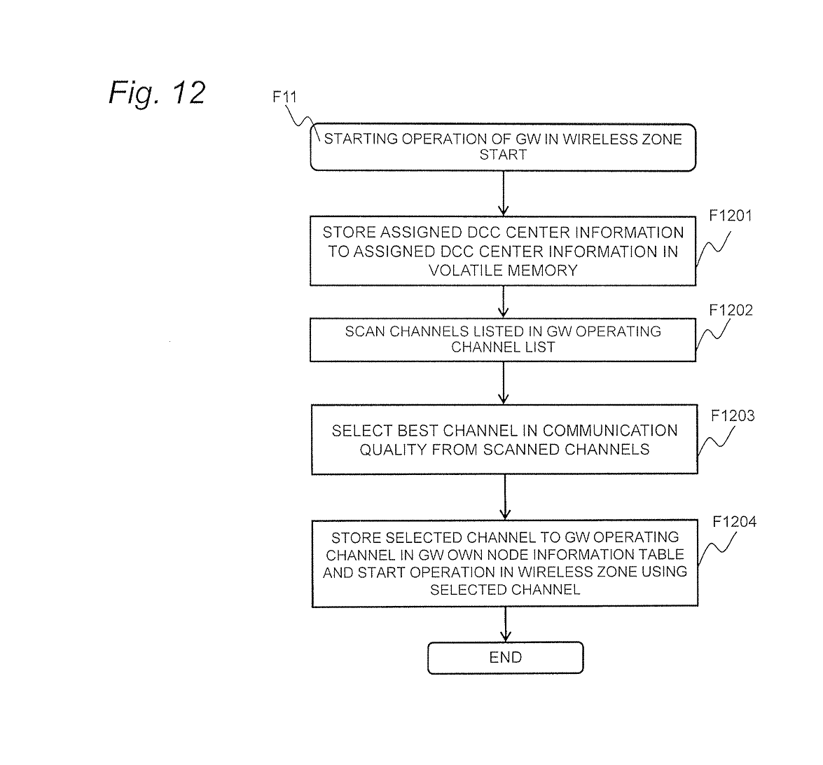

The GW system-connection unit 44 performs processing to connect to the M2M system 1 illustrated in FIG. 11. The wireless-zone operation start unit 45 performs processing to start operation in the wireless zone 105 illustrated in FIG. 12.

The network communication unit 46 makes communications with the network 107; the wireless-zone communication unit 47 makes communications with the wireless zone 105. The wireless-zone communication unit 47 connects to the SNs 106-a to 106-j via the wireless zone 105 using wireless lines. The network communication unit 46 or the wireless-zone communication unit 47 may include GPS as hardware.

The input/output unit 48 receives inputs from the user and displays information on the monitor. The processor 41 operates in accordance with the programs stored in the non-volatile memory 43 to work as functional units for implementing predetermined functions. The processor 41 further works as functional units for implementing a plurality of processes executed by the programs.

The functions of the GW system-connection unit 44, the wireless-zone operation start unit 45, the network communication unit 46, the wireless-zone communication unit 47, and the input/output unit 48 may be implemented by dedicated circuits, or otherwise, may be implemented by the processor 41 executing programs.

### Example of Information Stored in GW Own Node Information Table 50

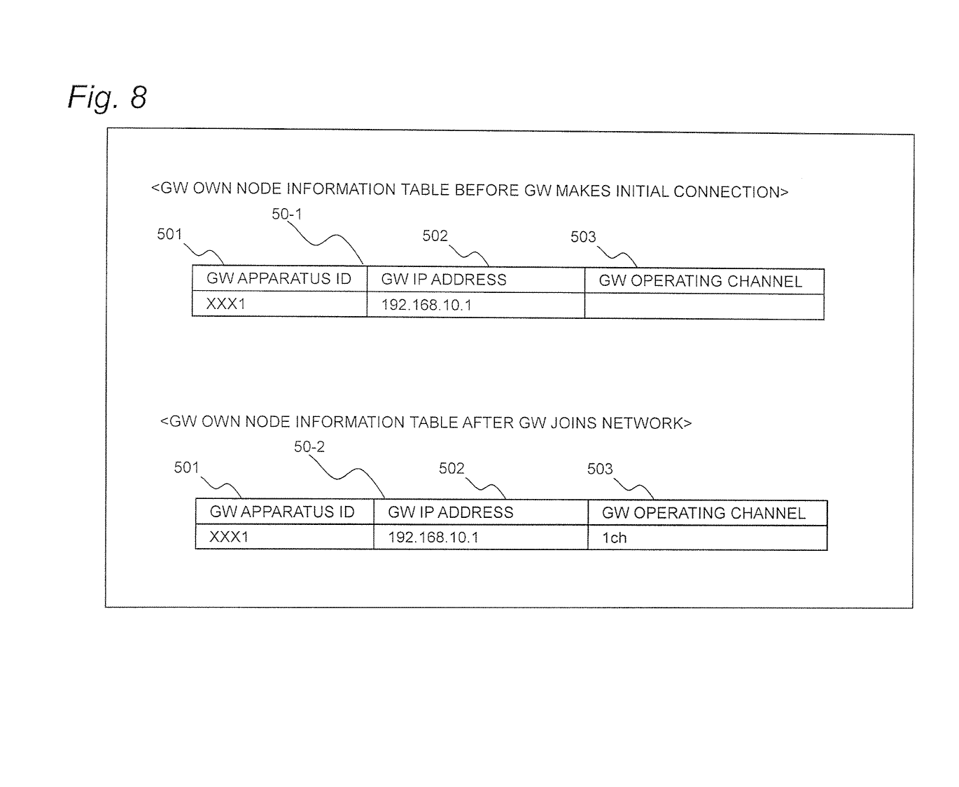

FIG. 8 is an explanatory diagram for illustrating examples of information stored in the GW own node information table 50 held by the GW 104-a. The GW own node information table 50-1 is an example of the GW own node information table 50 before the GW 104-a makes initial connection. The GW apparatus ID 501 is an ID for identifying the GW 104-a in the M2M system 1. The GW IP address 502 is a global IP address to be used for the GW 104-a to connect to the center system 100. The GW apparatus ID 501 and the GW IP address 502 are preset before apparatus activation of the GW 104-a. For example, the GW apparatus ID 501 and the GW IP address 502 may be set in the factory, or before apparatus activation. The GW operating channel 503 is a blank before initial connection of the GW 104-a.

The GW own node information table 50-2 is an example of the GW own node information table 50 after the GW 104-a joins the network. After the GW 104-a joins the network, the GW operating channel 503 stores the channel used by the GW 104-a. For example, the GW operating channel 503 of the GW own node information table 50-2 stores a value “1ch”. The method of determining the GW operating channel 503 will be described later.

### Configuration Example of SN 106

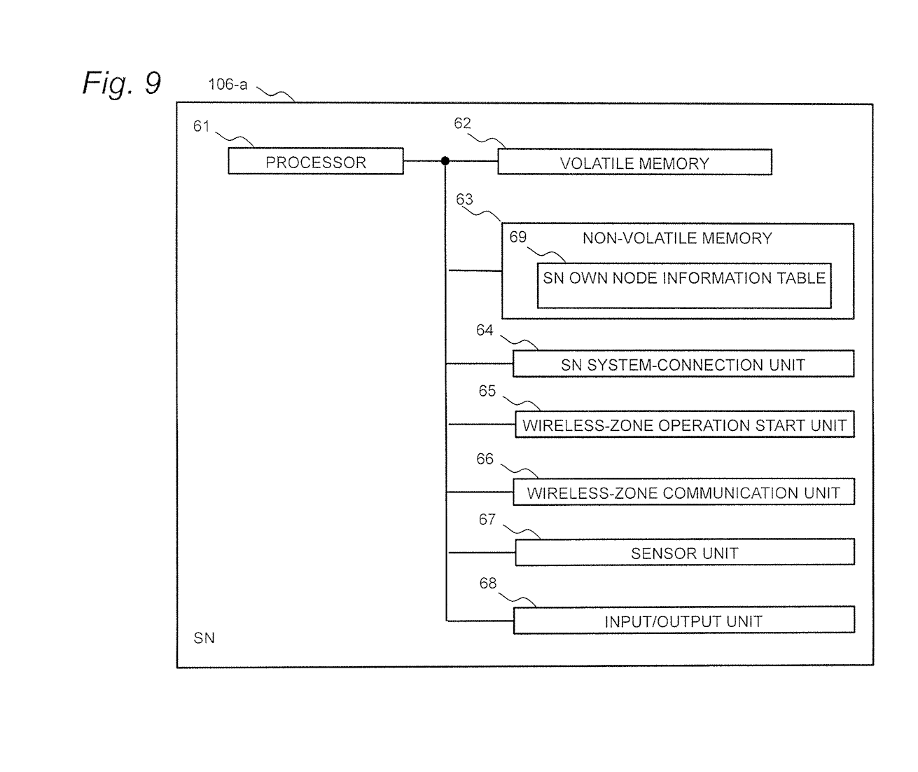

FIG. 9 is a block diagram for illustrating a configuration example of an SN 106. Although FIG. 9 provides an example of the SN 106-a, the SN 106-b to 106-j have the same configuration as the SN 106-a. The SN 106-a includes a processor 61 for performing arithmetic operations, a volatile memory 62, a non-volatile memory 63, an SN system-connection unit 64, a wireless-zone operation start unit 65, a wireless-zone communication unit 66, a sensor unit 67, and an input/output unit 68.

The volatile memory 62 holds programs and data on a temporary basis. The non-volatile memory 63 holds an SN own node information table 69 in addition to programs and data. Examples of the non-volatile memory 63 include storage devices such as a non-volatile semiconductor device, a hard disk drive, and an SSD (Solid State Drive), and computer-readable non-transitory data storage media such as an IC card, an SD card, a CD, and a DVD.

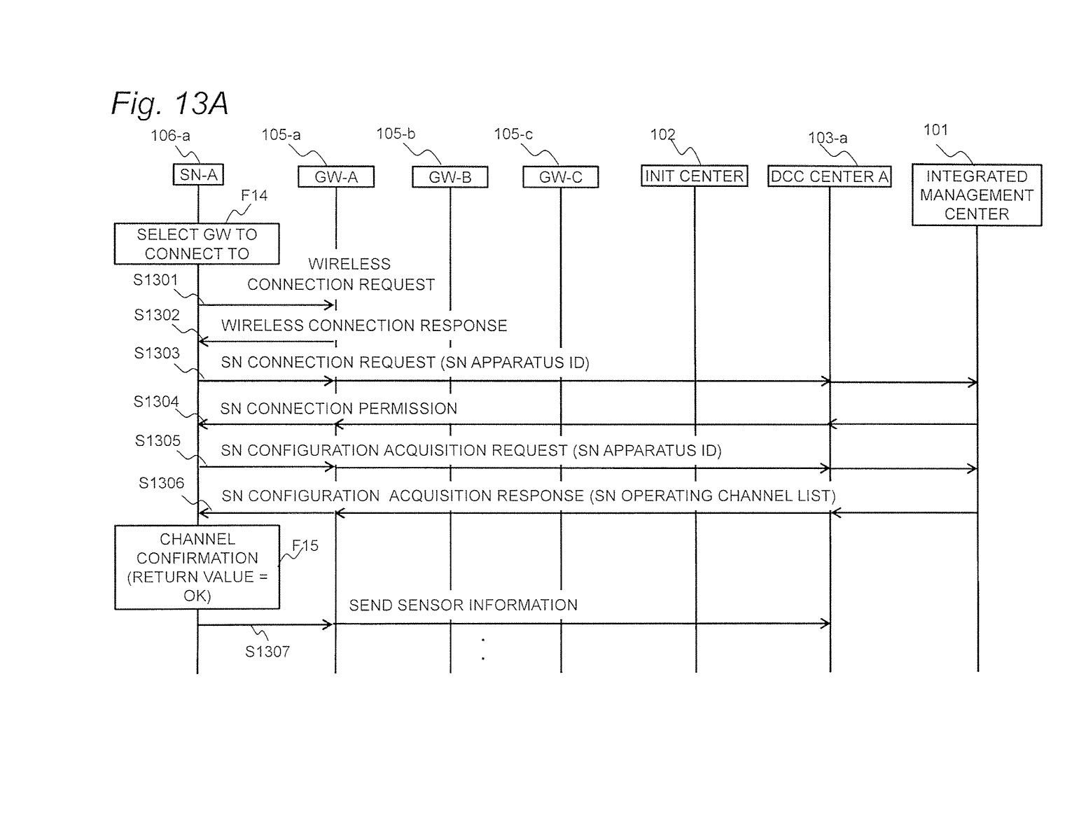

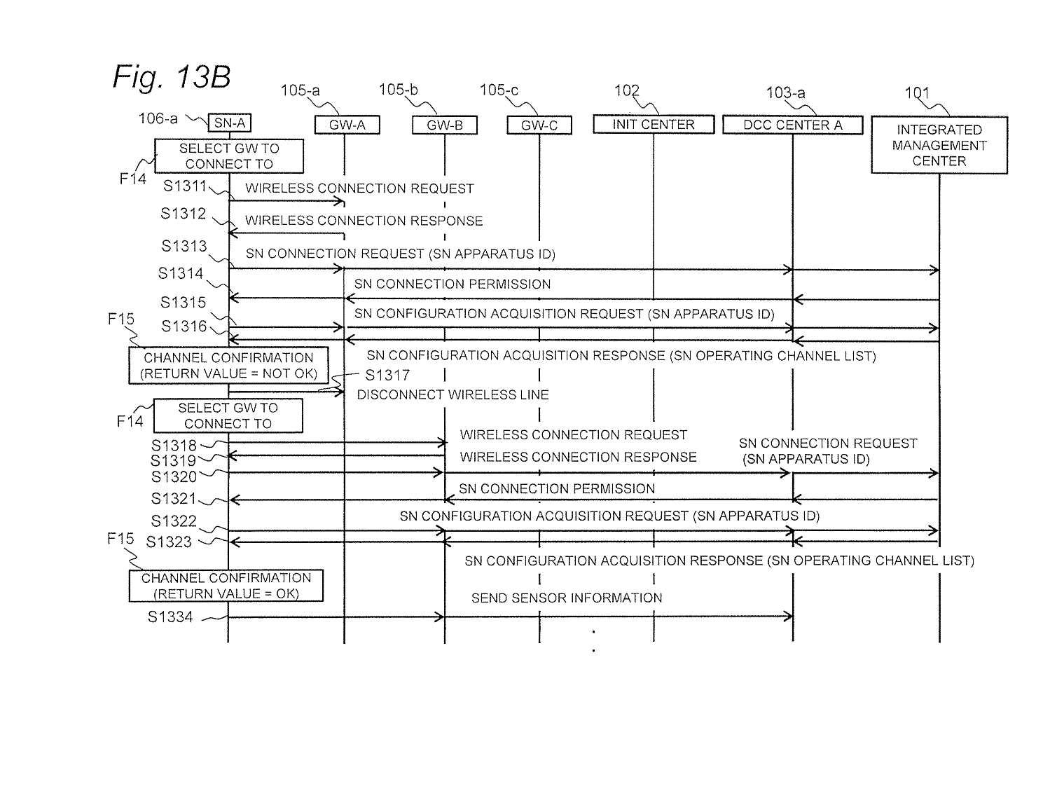

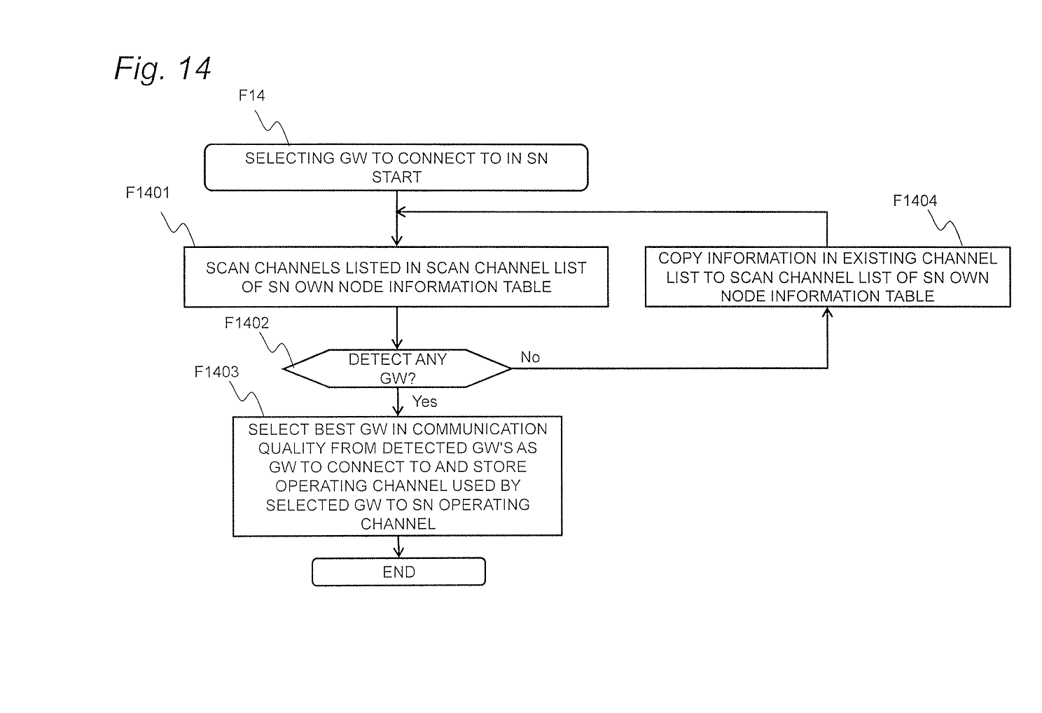

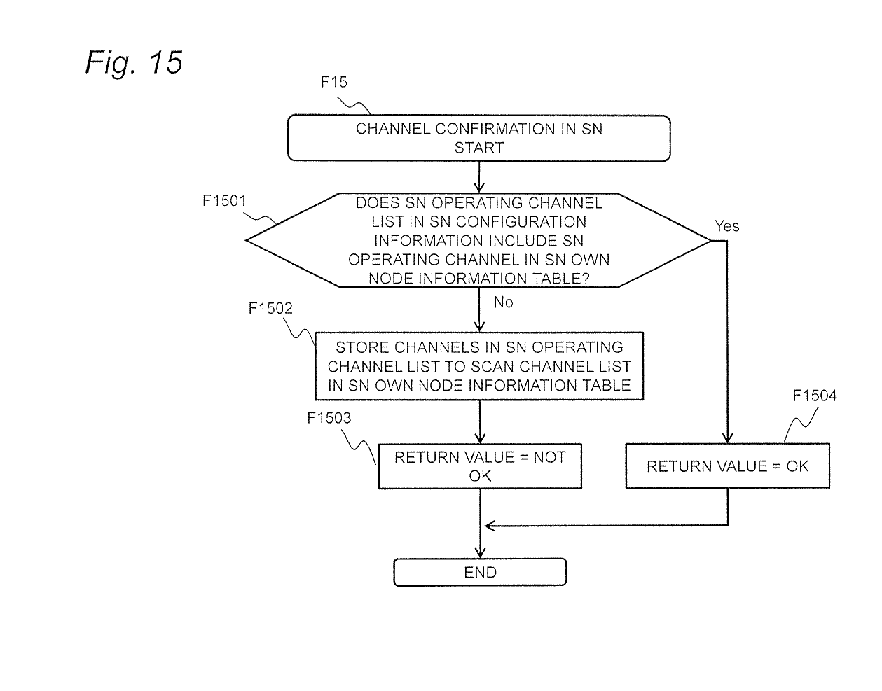

The SN system-connection unit 64 performs processing to connect to the M2M system 1 illustrated in FIG. 13. The wireless-zone operation start unit 65 pedal ins processing to select the GW 104-a to connect to illustrated in FIG. 14 and processing to confirm in the channel for the SN 106-a illustrated in FIG. 15.

The wireless-zone communication unit 66 makes communications with the wireless zone 105. The wireless-zone communication unit 66 may include GPS as hardware. The wireless-zone communication unit 66 connects to one of the GWs 104-a to 104-c via the wireless zone 105, using a wireless line.

The sensor unit 67 acquires sensor information on temperature, pressure, electricity, and/or magnetism as necessary by sensing. The sensor unit 67 may not be mounted inside the SN 106-a as shown in FIG. 9. The SN 106-a may be connected with a not-shown external sensor as necessary. In this case, common interfaces for connecting the SN 106-a and the external sensor are serial connection and two-wire connection.

The input/output unit 68 receives inputs from the user or displays information on the monitor. The processor 61 operates in accordance with the programs stored in the non-volatile memory 63 to work as functional units for implementing predetermined functions. The processor 61 further works as functional units for implementing a plurality of processes executed by the programs.

The functions of the SN system-connection unit 64, the wireless-zone operation start unit 65, the wireless-zone communication unit 66, the sensor unit 67, and the input/output unit 68 may be implemented by dedicated circuits, or otherwise, may be implemented by the processor 61 executing programs.

### Example of Information Stored in SN Own Node Information Table 69

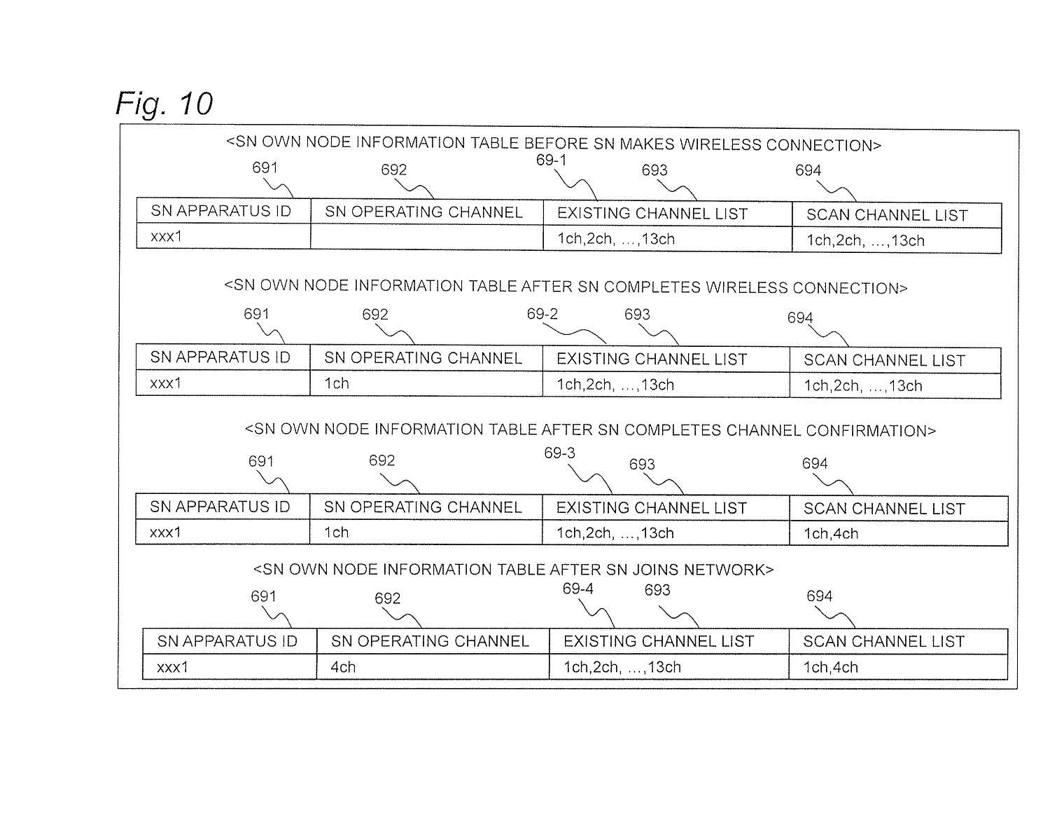

FIG. 10 is a block diagram for illustrating examples of information stored in the SN own node information table 69 held by the SN 106-a. The SN own node information table 69-1 is an example of the SN own node information table 69 before the SN 106-a makes wireless connection. The SN apparatus ID 691 is an ID for identifying the SN 106-a in the M2M system 1. The SN apparatus ID 691 is preset before apparatus activation of the SN 106. For example, the SN apparatus ID 691 may be set in the factory, or before the apparatus activation.

The SN operating channel 692 is a blank before the SN 106-a makes wireless connection. The existing channel list 693 is a list of channels available for the SN 106-a to scan in the wireless zone 105. The existing channel list 693 is preset before apparatus activation of the SN 106. For example, the existing channel list 693 may be set in the factory, or before the apparatus activation.

The scan channel list 694 is a list of channels to be scanned for the SN 106-a to search for a connectable GW 104. The channels to be scanned are channels being operated in the wireless zone 105 by the GWs 104. Before the SN 106-a joins the network, the scan channel list 694 includes the same information as the existing channel list 693.

The SN own node information table 69-2 is an example of the SN own node information table 69 after the SN 106-a completes wireless connection to a GW 104. After completion of wireless connection of the SN 106-a, the SN operating channel 692 stores the channel used by the SN 106-a in the wireless zone 105. The method of determining the SN operating channel 692 and the scan channel list 694 in making wireless connection of the SN 106-a will be described later.

The SN own node information table 69-3 is an example of the SN own node information table 69 after the SN 106-a completes channel confirmation illustrated in FIG. 15. After the SN 106-a completes channel confirmation, the SN operating channel 692 stores the channel to be used by the SN 106-a in the wireless zone 105. The method of determining the SN operating channel 692 and the scan channel list 694 in the channel confirmation in the SN 106-a will be described later.

The SN own node information table 69-4 is an example of the SN own node information table 69 after the SN 106-a joins the network. After the SN 106-a joins the network, the SN operating channel 692 stores the channel used by the SN 106-a in the wireless zone 105. The method of determining the SN operating channel 692 will be described later.

### Operation Sequence for GW 104 to Join Network

FIG. 11 is an explanatory diagram for illustrating an example of the operation sequence for a GW 104 to join the network.

S1101: Upon apparatus activation, the GW 104-a connects to the INIT center 102 with reference to the INIT center information 51 for initial connection stored in the non-volatile memory 43. The GW 104-a sends a GW connection request including terminal information or the GW apparatus ID 501 to the INIT center 102. Upon initial connection from the GW 104-a, the INIT center 102 forwards the GW connection request received from the GW 104-a to the integrated management center 101.

S1102: The integrated management center 101 searches the GW apparatus IDs 161 in the GW management table 16 for the GW apparatus ID 501 included in the GW connection request received via the INIT center 102. As a result of the search, if an entry including the GW apparatus ID 161 identical to the GW apparatus ID 501 included in the GW connection request exists in the GW management table 16, the integrated management center 101 sends a GW connection permission to the INIT center 102. The INIT center 102 forwards the GW connection permission received from the integrated management center 101 to the GW 104-a.

S1103: Upon receipt of the GW connection permission, the GW 104-a sends a GW configuration acquisition request including terminal information of the GW apparatus ID 501 to the INIT center 102. The INIT center 102 forwards the GW configuration acquisition request received from the GW 104-a to the integrated management center 101.

S1104: The integrated management center 101 searches the GW apparatus IDs 161 in the GW management table 16 for the GW apparatus ID 501 included in the GW configuration acquisition request received via the INIT center 102. The integrated management center 101 includes the GW configuration information 163 in the entry of the GW apparatus ID 161 detected through the search into a GW configuration acquisition response and sends the GW configuration acquisition response to the INIT center 102. The INIT center 102 forwards the GW configuration acquisition response received from the integrated management center 101 to the GW 104-a.

S1105: Upon receipt of the GW configuration acquisition response, the GW 104-a starts operation in the wireless zone 105 in accordance with the process flow F11 to be described later. After starting operation, the GW 104-a sends information of the GW 104-a to the DCC center 103-a. The information to be sent from the GW 104-a at S1105 is, for example, statistical information. The method for the GW 104-a to switch the access to the center system 100 from the INIT center 102 to the DCC center 103-a after the start of operation of sending information will be described later.

### Starting Operation of GW 104-a in Wireless Zone 105

FIG. 12 is a flowchart for illustrating an example of starting operation of the GW 104-a in the wireless zone 105. FIG. 12 corresponds to the foregoing F11.

F1201: The GW 104-a stores the assigned DCC center information 1632 in the GW configuration information 163 included in the GW configuration acquisition response received at S1104 in FIG. 11 to the assigned DCC center information 49 in the volatile memory 42. After F 1201, the GW 104-a connects to the DCC center 103 using the assigned DCC center information 49 stored in the volatile memory 42 in connecting to the center system 100. That is to say, the access from the GW 104-a to the center system 100 is switched from the INIT center 102 to the DCC center 103-a.

F1202: The GW 104-a refers to the GW operating channel list 1631 in the GW configuration information 163 included in the received GW configuration acquisition response and scans all the channels listed in the GW operating channel list 1631 for the wireless zone 105.

F1203: The GW 104-a selects a channel to be used for the connection from the scanned channels. In selecting a channel, the GW 104-a selects the best channel in communication quality, for example. Any method can be employed to calculate the communication quality.

F1204: The GW 104-a stores the channel selected at F1203 to the GW operating channel 503 in the GW own node information table 50 and then starts operation in the wireless zone 105 using the selected channel. Since the GW 104-a has joined the network, the GW own node information table 50 changes from the GW own node information table 50-1 before joining the network to the GW own node information table 50-2 after joining the network.

### Operation Sequence for SN 106-a to Join Network

FIGS. 13A and 13B are explanatory diagrams for illustrating examples of a sequence for the SN 106-a to join the network. The first case is described with reference to FIG. 13A, in which operations for the SN 106-a to join the network and to send sensor information are performed via the first-connected GW 104-a.

The SN 106-a first selects a GW to connect to in accordance with the process flow F 14 to be described later and sends a wireless connection request to the selected GW 104-a (S1301). At this phase, the GW operating channel is 1ch in accordance with the process flow F11. That is to say, the GW own node information table 50 held by the GW 104-a is the table 50-2 after the GW 104-a joins the network, which holds a value 1ch in the GW operating channel 503 as shown in FIG. 8.

The GW 104-a sends a wireless connection permission to the SN 106-a. This operation completes connection of the SN 106-a to the GW 104-a in the wireless zone 105. That is to say, the SN own node information table 69 held by the SN 106-a becomes the SN own node information table 69-2 after completion of wireless connection (S1302). The GW 104-a may send a wireless connection refusal to the SN 106-a in response to the wireless connection request from the SN 106-a if the GW 104-a has already accommodated the maximum number of SNs 106, for example.

Next, the SN 106-a sends the GW 104-a an SN connection request including terminal information of the SN apparatus ID 691. As described above, the GW 104-a connects to the DCC center 103 with reference to the assigned DCC center information 49 stored in the volatile memory 42 in connecting to the center system 100 after F 1201. Accordingly, the SN connection request is forwarded to the integrated management center 101 via the GW 104-a and the DCC center 103-a (S1303).

Upon receipt of the SN connection request, the integrated management center 101 authenticates the terminal SN 106-a corresponding to the SN apparatus ID 691 included in the SN connection request. If the terminal authentication reveals that the SN 106-a is permitted to connect, the integrated management center 101 sends an SN connection permission to the DCC center 103-a. The SN connection permission is forwarded to the SN 106-a via the DCC center 103-a and the GW 104-a (S1304).

The SN 106-a that has received the SN connection permission sends an SN configuration acquisition request including terminal information of SN apparatus ID 691 to the GW 104-a. The SN configuration acquisition request is forwarded to the integrated management center 101 via the GW 104-a and the DCC center 103-a (S1305).

Upon receipt of the SN configuration acquisition request, the integrated management center 101 retrieves the SN management table 17 and searches the SN apparatus IDs 171 of the SN management table 17 for the SN apparatus ID 691 included in the SN configuration acquisition request. As a result of the search, if an entry including the SN apparatus ID 171 identical to the SN apparatus ID 691 in the SN configuration acquisition request exists in the SN management table 17, the integrated management center 101 includes the SN configuration information 173 associated with the detected SN apparatus ID 171 in an SN configuration acquisition response.

The integrated management center 101 sends the SN configuration acquisition response including the SN configuration information 173 to the DCC center 103-a. The SN configuration acquisition response including the SN configuration information 173 is forwarded to the SN 106-a via the DCC center 103-a and the GW 104-a (S 1306).

Next, the SN 106-a performs channel confirmation in accordance with the process flow F15 to be described later. If the return value from F15 is OK, the SN 106-a maintains the value 1ch for the SN operating channel 692 in the SN own node information table 69-2. That is to say, the SN own node information table 69 held by the SN 106-a changes from the SN own node information table 69-2 after completion of wireless connection to an SN own node information table 69 after channel confirmation. Although not shown in the drawing, the SN own node information table 69 after channel confirmation at this step takes over the information managed in the SN own node information table 69-2 after completion of wireless connection.

Through the foregoing operations, the SN 106-a completes joining the network; the SN 106-a starts collecting sensor information and sends the collected sensor information to the GW 104-a. The GW 104-a forwards the sensor information received from the SN 106-a to the DCC center 103-a (S1307).

The second case described with reference to FIG. 13B is a case where operations for the SN 106-a to join the network and to send sensor information are performed via a reselected GW 104-b. In this instance, it is assumed that the GW 104-a selects 5ch for the wireless zone 105 in the process flow F11 shown in FIG. 11 and starts operation on the selected 5ch. That is to say, the GW own node information table 50 holds a value 5ch in the GW operating channel 503 in the state 50-2 after joining the network, although not shown in the drawings.

The SN 106-a selects the GW 104-a by performing selecting a GW to connect to in accordance with the process flow F14 in FIG. 13B. Description of S1311 to S1316 in FIG. 13B is omitted because S1311 to S1316 are the same as S1301 to S1306 in FIG. 13A.

Next, the SN 106-a performs channel confirmation in accordance with the process flow F15 to be described later. If the return value of F15 is NOT OK, the SN 106-a sends a disconnection of the wireless line to the GW 104-a (S1317). The SN 106-a reselects a GW to connect to in accordance with the process flow F14 to be described later. For example, the GW 104-b using 4ch in the wireless zone 105 is newly selected at the end of F14. The SN 106-a sends a wireless connection request to the newly selected GW 104-b (S1318).

The GW 104-b sends a wireless connection permission to the SN 106-a like at S1312. This operation completes connection of the SN 106-a to the GW 104-b in the wireless zone 105 (S1319). After S1319, the SN own node information table 69 held by the SN 106-a, or the SN own node information table 69-2 after completion of wireless connection, stores a value 4ch in the SN operating channel 692.

Next, the SN 106-a sends the GW 104-b an SN connection request including terminal information of the SN apparatus ID 691, like at S1313. The SN connection request is forwarded to the integrated management center 101 via the GW 104-b and the DCC center 103-a (S1320).

The integrated management center 101 authenticates the SN 106-a, like at S1314. If the terminal authentication reveals that the SN 106-a is permitted to connect, the integrated management center 101 sends an SN connection permission to the DCC center 103-a. The SN connection permission is forwarded to the SN 106-a via the DCC center 103-a and the GW 104-b (S1321).

The SN 106-a that has received the SN connection permission sends an SN configuration acquisition request including terminal information of SN apparatus ID 691 to the GW 104-b, like at S1305. The SN configuration acquisition request is forwarded to the integrated management center 101 via the GW 104-b and the DCC center 103-a (S1322).

Upon receipt of the SN configuration acquisition request, the integrated management center 101 retrieves the SN management table 17 and searches the SN apparatus IDs 171 of the SN management table 17 for the SN apparatus ID 691 included in the SN configuration acquisition request, like at S1306. As a result of the search, if an entry including the SN apparatus ID 171 identical to the SN apparatus ID 691 included in the SN configuration acquisition request exists in the SN management table 17, the integrated management center 101 includes the SN configuration information 173 associated with the detected SN apparatus ID 171 in an SN configuration acquisition response.

The integrated management center 101 sends the SN configuration acquisition response including the SN configuration information 173 to the DCC center 103-a. The SN configuration acquisition response including the SN configuration information 173 is forwarded to the SN 106-a via the DCC center 103-a and the GW 104-b (S1323).

The SN 106-a performs channel confirmation again in accordance with the process flow F15. If the return value from F15 is OK, the SN 106-a completes joining the SN operating channel network. That is to say, the SN own node information table 69 held by the SN 106-a changes from the SN own node information table 69-3 after channel confirmation to the SN own node information table 69-4 after joining the network shown in FIG. 10.

Through the foregoing steps, the SN 106-a completes joining the network; the SN 106-a starts sending information of the SN 106-a to the GW 104-b. The GW 104-b forwards the information received from the SN 106-a to the DCC center 103-a (S1334). The information sent by the SN 106-a is, for example, sensor information and statistical information of the SN 106-a.

### Selecting GW to Connect To in SN 106-a

FIG. 14 is a flowchart for illustrating an example of processing to select a GW to connect to in the SN 106-a. FIG. 14 corresponds to F14 in FIGS. 13A and 13B.

The SN 106-a scans all the channels stored in the scan channel list 694 in the SN own node information table 69-1 (F1401).

The SN 106-a checks whether any connectable GW 104 has been detected in the scanning (F1402).

If one or more connectable GWs 104 are detected, or if the determination at F1402 is Yes, the SN 106-a selects a GW to connect to from the detected at least one GW 104. In selecting a GW, the SN 106-a selects the best GW in communication quality, for example. Any method can be used to calculate the communication quality. The SN 106-a stores the channel used by the selected GW to the SN operating channel 692 in the SN own node information table 69-2 (F1403). In the example of FIG. 13A, after the first processing F14 to select a GW to connect to, the SN own node information table 69 or the SN own node information table 69-2 after completion of wireless connection stores a value 1ch in the SN operating channel 692. In the example of FIG. 13B, after the first processing F14 to select a GW to connect to, the SN own node information table 69 or the SN own node information table after completion of wireless connection 69-2 stores a value 5ch in the SN operating channel 692, although not shown in the drawings.

If no connectable GW 104 is detected, or if the determination at F1402 is No, the SN 106-a copies the information in the existing channel list 693 of the SN own node information table 69-1 to the scan channel list 694 in order to re-scan all the channels stored in the existing channel list (F1404). After F1404, the SN 106-a executes F1401 again. In the case where no connectable GW 104 is detected at F1402, the SN 106-a may re-execute F1404 after a specific time.

### Channel Confirmation in SN 106-a

FIG. 15 is a flowchart for illustrating an example of channel confirmation in the SN 106-a. FIG. 15 corresponds to F15 in FIGS. 13A and 13B.

Upon receipt of an SN configuration acquisition response at S1306 in FIG. 13A, the SN 106-a checks whether the SN operating channel 692 in the SN own node information table 69-2 is included in the channels stored in the SN operating channel list 1731 in the SN configuration information 173 included in the SN configuration acquisition response (F1501).

If the SN operating channel 692 of the SN 106-a is included in the SN operating channel list 1731 in the SN configuration information 173, or the determination at F1501 is Yes, the SN 106-a determines the return value to be OK (F1504) and exits the channel confirmation in the SN.

If the SN operating channel 692 of the SN 106-a is not included in the SN operating channel list 1731 in the SN configuration information 173, or the determination at F1501 is No, the SN 106-a stores the channels stored in the SN operating channel list 1731 to the scan channel list 694 in the SN own node information table 69-3 to scan all the channels stored in the SN operating channel list 1731 in the SN configuration information 173.

Taking a specific example of FIG. 4, the SN operating channel list 1731 for the SN apparatus ID 171 of the SN 106-a, xxx1, includes 1ch and 4ch. Hence, the SN 106-a stores the channels 1ch and 4ch stored in the SN operating channel list 1731 to the scan channel list 694 in the SN own node information table 69-3 shown in FIG. 10 (F1502). The SN 106-a determines the return value to be NOT OK (F1503) and exits the channel confirmation in the SN.

The configurations, processing units, and processing of the computers described in the above-described embodiment may be, for all or a part of them, implemented by dedicated hardware. A variety of software exemplified in the embodiment can be stored in various types of storage media (for example, non-transitory storage media) such as electromagnetic media, electronic media, and optical media, and can be downloaded to a computer through a communication network such as the Internet.

This invention has been described in detail so far with reference to the accompanying drawings, but this invention is not limited to those specific configurations described above, and includes various changes and equivalent components.

Also, the wireless zone 105 is realized by a short-range wireless communication function. The short-range wireless communication includes a system which adopted IP(Internet Protocol), such as Wi-Fi(Wireless-Fidelity), Wi-Fi Direct, and Bluetooth(Trade Mark), or a transmissible system with non-IP, such as Zigbee (Trade Mark).

What is claimed is:

1. An information collection system comprising:
a center system; and
relay terminals connectable to the center system via a network,
the center system including:
a first server for each of the relay terminals to initially connect to;
a second server for each of the relay terminals to send sensor information; and
a third server configured to manage the first server and the second server, and
each of the relay terminal including:
a first storage unit configured to hold relay terminal information for managing information on an operating channel to be used by the relay terminal and information to connect to the first server; and
a relay terminal operation start unit configured to select an operating channel to be used by the relay terminal from channels scanned based on information on candidate operating channels for the relay terminal received from the third server via the first server.

2. The information collection system according to claim 1,
wherein the information collection system further comprises sensor terminals capable of sending sensor information to a relay terminal via a wireless zone, and
wherein the relay terminal operation start unit is configured to select an operating channel to be used by the relay terminal in the wireless zone from channels in the wireless zone scanned based on the received information on candidate operating channels for the relay terminal.

3. The information collection system according to claim 2,
wherein each of the relay terminals further includes a relay terminal connection unit configured to receive relay terminal configuration information including the information on candidate operating channels for the relay terminal and information to connect to the second server, and
wherein the relay terminal operation start unit is configured to store the received information to connect to the second server to the first storage unit.

4. The information collection system according to claim 3,
wherein each of the sensor terminals includes:
a sensor terminal operation start unit;
a sensor terminal connection unit; and
a second storage unit configured to hold sensor terminal information for managing information on an operating channel to be used by the sensor terminal and information on candidate channels to be scanned,
wherein the sensor terminal operation start unit is configured to:
select an operating channel for the sensor terminal to use to connect to a relay terminal from channels scanned based on the information on candidate channels to be scanned stored in the second storage unit;
store the selected operating channel to be used by the sensor terminal to the sensor terminal information; and
check whether information on candidate operating channels for the sensor terminal received from the center system via a connected relay terminal includes the operating channel to be used by the sensor terminal stored in the sensor terminal information, and
wherein the sensor terminal connection unit is configured to send collected sensor information to the connected relay terminal on the operating channel to be used by the sensor terminal stored in the sensor terminal information in a case where a result of the checking is affirmative.

5. The information collection system according to claim 4, wherein the sensor terminal operation start unit is configured to:
update the information on candidate channels to be scanned by storing the received information on candidate operating channels for the sensor terminal to the information on candidate channels to be scanned in a case where a result of the checking is negative; and
reselect an operating channel to be used by the sensor terminal to connect to another relay terminal from channels scanned based on the updated information on candidate channels to be scanned, after disconnecting from the connected relay terminal.

6. The information collection system according to claim 4, wherein the relay terminal connection unit is configured to:
send a sensor terminal connection request received from a sensor terminal to the second server with reference to the information to connect to the second server stored in the first storage unit of the relay terminal, after being connected from the sensor terminal;
send a sensor terminal configuration information acquisition request to the second server upon receipt of a sensor terminal connection permission from the third server via the second server;
receive sensor terminal configuration information including the information on candidate operating channels for the sensor terminal from the third server via the second server;
forward the received sensor terminal configuration information to the sensor terminal; and
send the sensor information received after the checking from the sensor terminal to the second server with reference to the information to connect to the second server stored in the first storage unit of the relay terminal.

7. The information collection system according to claim 6,
wherein the second server includes an information collection unit configured to collect the sensor information sent from the relay terminals and to forward the collected sensor information to the third server, and
wherein the third server includes a third storage unit configured to hold relay terminal management information for managing the information on candidate operating channels and the information to connect to the second server for each of the relay terminals, sensor terminal management information for managing information on candidate operating channels for each of the sensor terminals, and the forwarded sensor information.

8. A relay terminal connectable to a center system via a network, the relay terminal comprising:
a storage unit configured to hold relay terminal information for managing an operating channel to be used by the relay terminal and information to connect to a first server, the first server being included in the center system and to be initially connected from the relay terminal; and
a relay terminal operation start unit configured to select an operating channel to be used by the relay terminal from channels scanned based on information on candidate operating channels for the relay terminal received from the center system via the first server.

9. The relay terminal according to claim 8,
wherein the relay terminal is capable of receiving sensor information via a wireless zone, and
wherein the relay terminal operation start unit is configured to select an operating channel to be used by the relay terminal in the wireless zone from channels in the wireless zone scanned based on the received information on candidate operating channels for the relay terminal.

10. The relay terminal according to claim 9,
wherein the relay terminal further comprises a relay terminal connection unit configured to receive relay terminal configuration information from the center system via the first server,
wherein the relay terminal configuration information includes the information on candidate operating channels for the relay terminal and information to connect to a second server, the second server being included in the center system and to be sent the sensor information from the relay terminal, and
wherein the storage unit is configured to store the received information to connect to the second server.

11. The relay terminal according to claim 10, wherein the relay terminal connection unit is configured to:
send a relay terminal connection request to the first server with reference to the information to connect to the first server in initial connection to the center system;
send a relay terminal configuration information acquisition request to the first server upon receipt of a relay terminal connection permission from the center system via the first server; and
receive the relay terminal configuration information from the center system via the first server.

12. A control method for a relay terminal to connect to a center system via a network, the control method comprising:
holding, by the relay terminal, relay terminal information for managing an operating channel to be used by the relay terminal and information to connect to a first server in a storage unit, the first server being included in the center system and to be initially connected from the relay terminal; and
selecting, by the relay terminal, an operating channel to be used by the relay terminal from channels scanned based on information on candidate operating channels for the relay terminal received from the center system via the first server.

13. The control method for a relay terminal to connect to a center system according to claim 12, further comprising:
receiving, by the relay terminal, sensor information via a wireless zone; and
selecting, by the relay terminal, an operating channel to be used by the relay terminal in the wireless zone from channels in the wireless zone scanned based on the received information on candidate operating channels for the relay terminal.

14. The control method for a relay terminal to connect to a center system according to claim 13, further comprising:
sending, by the relay terminal, a relay terminal connection request to the first server with reference to the information to connect to the first server in initial connection to the center system;
sending, by the relay terminal, a relay terminal configuration information acquisition request to the first server upon receipt of a relay terminal connection permission from the center system via the first server;
receiving, by the relay terminal, relay terminal configuration information including the information on candidate operating channels for the relay terminal and information to connect to a second server from the center system via the first server, the second server being included in the center system and to send sensor information sent from the relay terminal; and
storing, by the relay terminal, the received information to connect to the second server to the storage unit.

15. A sensor terminal capable of sending sensor information to a relay terminal via a wireless zone, the relay terminal being connected with a center system via a network, the sensor terminal comprising:
a sensor terminal operation start unit;
a sensor terminal connection unit; and
a storage unit configured to hold sensor terminal information for managing information on an operating channel to be used by the sensor terminal and information on candidate channels to be scanned,
wherein the sensor terminal operation start unit is configured to:
select an operating channel for the sensor terminal to use to connect to a relay terminal from channels scanned based on the information on candidate channels to be scanned stored in the storage unit;
store the selected operating channel to be used by the sensor terminal to the sensor terminal information; and
check whether information on candidate operating channels for the sensor terminal received from the center system via a connected relay terminal includes the operating channel to be used by the sensor terminal stored in the sensor terminal information, and
wherein the sensor terminal connection unit is configured to send collected sensor information to the connected relay terminal on the operating channel to be used by the sensor terminal stored in the sensor terminal information in a case where a result of the checking is affirmative.

16. The sensor terminal according to claim 15, wherein the sensor terminal operation start unit is configured to:
update the information on candidate channels to be scanned by storing the received information on candidate operating channels for the sensor terminal to the information on candidate channels to be scanned in a case where a result of the checking is negative; and
reselect an operating channel to be used by the sensor terminal to connect to another relay terminal from channels scanned based on the updated information on candidate channels to be scanned, after disconnecting from the connected relay terminal.

17. A control method for a sensor terminal to connect to a center system, the sensor terminal being capable of sending sensor information to a relay terminal via a wireless zone, the relay terminal being connected with a center system via a network, and the control method comprising:
holding, by the sensor terminal, sensor terminal information for managing information on an operating channel to be used by the sensor terminal and information on candidate channels to be scanned,
selecting, by the sensor terminal, an operating channel for the sensor terminal to use to connect to the relay terminal from channels scanned based on the information on candidate channels to be scanned stored in the storage unit;
storing, by the sensor terminal, the selected operating channel to be used by the sensor terminal to the sensor terminal information;
checking, by the sensor terminal, whether information on candidate operating channels for the sensor terminal received from the center system via a connected relay terminal includes the operating channel to be used by the sensor terminal stored in the sensor terminal information; and
sending, by the sensor terminal, collected sensor information to the connected relay terminal on the operating channel to be used by the sensor terminal stored in the sensor terminal information in a case where a result of the checking is affirmative.

18. The control method for a sensor terminal to connect to a center system according to claim 17, further comprising:
updating, by the sensor terminal, the information on candidate channels to be scanned by storing the received information on candidate operating channels for the sensor terminal to the information on candidate channels to be scanned in a case where a result of the checking is negative; and
reselecting, by the sensor terminal, an operating channel to be used by the sensor terminal to connect to another relay terminal from channels scanned based on the updated information on candidate channels to be scanned, after disconnecting from the connected relay terminal.
